(19) United States
(12) Patent Application Publication
(10) Pub. No.: US 2024/0402035 A1
(43) Pub. Date: Dec. 5, 2024

(54) METHOD FOR DETERMINING THE POSITION OF A LEAK IN A TIRE

(71) Applicant: Continental Automotive Technologies GmbH, Hannover (DE)

(72) Inventors: Mihai Barbalata, Timisoara (RO); Mihai Voinescu, Regensburg (DE)

(73) Assignee: Continental Automotive Technologies GmbH, Hannover (DE)

(21) Appl. No.: 18/678,098

(22) Filed: May 30, 2024

(30) Foreign Application Priority Data
May 30, 2023 (EP) 23465514.0

(51) Int. Cl. G01M 3/26; G01M 17/02

(52) U.S. Cl. CPC G01M 3/26; G01M 17/02

(57) ABSTRACT

A method for determining the position of a leak in a tire fitted to a vehicle, which has a sensor unit having a tire pressure sensor for capturing tire pressure data of the tire, wherein the tire pressure data are received and evaluated by a processing device of the vehicle, wherein a time curve of the tire pressure of the tire is established with the aid of the tire pressure data, and wherein the position of the leak is determined based on the curve of the tire pressure.

### CROSS-REFERENCE TO RELATED APPLICATIONS

The present application is a bypass continuation application of DE 10 2023 205 070.6 filed on May 31, 2023, in the DE Intellectual Property Office, the disclosure of which is herein incorporated by reference in its entirety.

### BACKGROUND

### 1. Field

Embodiments of the present application relate to a method for determining the position of a leak in a tire fitted to a vehicle, which has a sensor unit having a tire pressure sensor for capturing tire pressure data of the tire, wherein the tire pressure data are received and evaluated by a processing device of the vehicle. Furthermore, embodiments of the present application relate to a tire pressure monitoring system having a processing device which is configured to perform such a method.

### 2. Description of Related Art

Nowadays, a tire pressure control system, also referred to as a tire pressure monitoring system, is usually used in vehicles. Such a system typically comprises a respective sensor unit arranged in or on the wheels, in particular in or on the tires of the wheels, of a vehicle, which in particular captures, by means of a tire pressure sensor, a current internal air pressure of the corresponding tire, that is to say a corresponding tire pressure. The captured tire pressure data are transmitted wirelessly, for example by means of high frequencies (HF), to a processing device or a so-called receiver of the tire pressure monitoring system and evaluated by the processing device. The processing device can be assigned as an independent unit, in particular an independent controller, permanently and solely, to the tire pressure monitoring system or be part of another controller of the vehicle, for example a bodywork controller.

In particular, the tire pressure monitoring system monitors the tire pressure of each tire of the vehicle and alerts the driver if an abnormality in one or more tires should occur, for example if the tire pressure value of a tire drops below a certain threshold. The alerting or warning of the tire pressure monitoring system is usually based on current filling pressure values of the tire or current tire pressure values. If a tire is adversely affected by a leak, for example due to a hole or a nail in the tire, and the tire is refilled with air, for example, by the driver after receiving an alert to this effect, the tire pressure will drop again after a while due to the leak, and the alert is reactivated.

That is to say that the driver does not learn, thanks to the tire pressure monitoring system, whether the pressure drop can be attributed to a normal or usual escape of gas or air, that is to say which is not caused by a leak, or whether the tire has an unusual leak, and certainly not at which point or in which region of the tire a corresponding leak is occurring.

### SUMMARY

Against this backdrop, it is now an object of the embodiments to indicate a method for determining the position of a leak in a tire fitted to a vehicle as well as a corresponding tire pressure monitoring system which makes it possible to determine the position of a leak in a simple and reliable manner.

In the case of the method according to an embodiment for determining the position of a leak in a tire fitted to a vehicle, which has a sensor unit having a tire pressure sensor for capturing tire pressure data of the tire, the tire pressure data are received and evaluated by a processing device of the vehicle, wherein a time curve of the tire pressure of the tire is established with the aid of the tire pressure data, and wherein the position of the leak is determined based on the curve of the tire pressure.

An embodiment is in particular based on the realization that a leak in a tire regularly occurs in the region of the tread of the tire, and, that is to say, that during the rotation of the wheel or tire, when the region or section of the tread in which the leak is arranged comes into contact with the ground, detectable specific pressure abnormalities or pressure fluctuations occur in the curve of the tire pressure or in the curve of the pressure drop of the tire pressure right up to a sudden, abrupt and brief suspension of the (further) pressure drop during the corresponding tire contact area run-through time. As a consequence, a basic idea of an embodiment is based on establishing a time curve of the tire pressure of the tire and of determining the position of the leak based on this curve. Advantageously, the position of the leak is determined based on a pressure drop of the tire pressure over time.

The advantage of the configuration according to an embodiment is that it provides a method by means of which it is possible to determine the position of a leak in a tire fitted to a vehicle in a simple and reliable manner. For example, the knowledge of the position of the leak in the tire means that a decision regarding the possibility of repairing the tire can be made simply and quickly and/or the tire can be quickly repaired. In addition, the information regarding the position of the leak or the knowledge of the position of the leak is relevant, for example, for an autonomously driving vehicle when the vehicle is to decide virtually independently whether it must stop immediately, for example, or call at the nearest workshop.

The sensor unit and the tire pressure sensor advantageously have a fixed fastening position having a fixed alignment with regard to the tire and/or wheel.

In an advantageous embodiment, the position of the leak is determined with the aid of a characteristic feature of the curve of the tire pressure, wherein a characteristic feature is a tire pressure and, in particular, a suddenly occurring, consistent or substantially consistent tire pressure, for a predetermined period of time. That is to say that the characteristic feature in the curve of the tire pressure is in particular embodied in such a way that, for a predetermined period of time, in particular suddenly, no change or no significant change in the tire pressure, in particular if, suddenly, no or only a very small (further) pressure drop of the tire pressure, is present in the time curve. That is to say that, here, in order to determine the position of the leak, the curve of the tire pressure is examined for a consistent or substantially consistent tire pressure for a predetermined period of time as the characteristic feature, wherein the position of the leak is determined with the aid of this characteristic feature or the occurrence of this characteristic feature, in particular if a pressure drop of the tire pressure has been detected immediately prior to the occurrence of the consistent or substantially consistent tire pressure for the predetermined period of time.

In a further advantageous embodiment, the position of the leak is determined with the aid of a characteristic feature of a variable characterizing the curve of the tire pressure, wherein the characterizing variable is preferably configured as a gradient of the curve of the tire pressure. That is to say that, in this case, the gradient of the curve of the tire pressure is established and, based on the gradient of the curve, the position of the leak is determined. The position of the leak, on the one hand, can be determined solely with the aid of a characteristic feature of a variable characterizing the curve of the tire pressure or, on the other hand, with the aid of a characteristic feature of a variable characterizing the curve of the tire pressure and with the aid of a characteristic feature of the (immediate) curve of the tire pressure.

In a further advantageous embodiment, a first derivative over time and/or a second derivative over time of the curve of the tire pressure is/are established, wherein the position of the leak is determined based on the first derivative over time and/or the second derivative over time, preferably based on a curve of the first derivative over time and/or a curve of the second derivative over time. The first derivative over time and the second derivative over time are in particular the mathematical first derivative in accordance with the time and the mathematical second derivative in accordance with the time, respectively. The first derivative over time constitutes, in particular, the gradient of the curve of the tire pressure. The position of the leak can be established in a particularly simple and reliable manner with the aid of the established first derivative over time and/or second derivative over time.

In a further advantageous embodiment, a first derivative over time of the curve of the tire pressure is established, wherein the first derivative over time of the curve of the tire pressure is equal to or virtually zero as a characteristic feature, and wherein the position of the leak is determined with the aid of this characteristic feature. That is to say that the first derivative over time of the curve of the tire pressure or the curve of the first derivative over time is examined for a value equal to or virtually zero as the characteristic feature in order to determine the position of the leak, wherein the position of the leak is determined with the aid of this characteristic feature or the occurrence of this characteristic feature.

Alternatively or additionally, in a further advantageous embodiment, a first derivative over time of the curve of the tire pressure is established, wherein a characteristic feature is a global or local minimum value of the second derivative over time of the curve of the tire pressure, and wherein the position of the leak is alternatively or additionally determined with the aid of this characteristic feature. That is to say that, in order to determine the position of the leak here, the second derivative over time of the curve of the tire pressure or the curve of the second derivative over time is examined for a global or local minimum value as the characteristic feature, wherein the position of the leak is determined with the aid of this characteristic feature or the occurrence of this characteristic feature. Advantageously, the first derivative over time of the curve of the tire pressure is equal to or virtually zero as a characteristic feature, and a global or local minimum value of the second derivative over time of the curve of the tire pressure is a further characteristic feature, wherein the position of the leak is determined with the aid of one or both characteristic features.

In a further advantageous embodiment, the sensor unit has an acceleration sensor for capturing an acceleration relating to the tire, wherein the acceleration data captured by the acceleration sensor are received by the processing device and a rotation angle of the tire is established based on the acceleration data, and wherein the position of the leak is (in addition) determined based on the established rotation angle. Advantageously, the acceleration sensor has a fastening position having fixed alignment (orientation) with regard to the tire. The acceleration sensor is designed to capture an acceleration relating to the tire, wherein the captured acceleration is oscillated when the tire is moving. The acceleration is preferably a radial acceleration or a radial component of the acceleration, which contains both an acceleration of the centrifugal force and an acceleration of the gravitational force, wherein the radial acceleration direction is in particular perpendicular to the rotation axis and perpendicular to the circumferential direction of the tire and directed parallel to a radius of the circular shape. The radial acceleration or the radial component of the acceleration can be directly captured or established by the acceleration sensor. However, the radial acceleration or the radial component of the acceleration can also (first) be established by the processing device with the aid of the acceleration data captured by the acceleration sensor. As a function of the captured acceleration, in particular the radial acceleration or the radial component of the acceleration, a rotation angle of the tire is preferably determined with respect to a contact with the ground on which the vehicle is driving by means of the tire, wherein it is in particular determined here whether or when the acceleration sensor and, therefore, also the sensor unit having the tire pressure sensor is located in contact with the ground, that is to say in the 6 o'clock position, and/or at the position opposite the contact with the ground, that is to say in the 12 o'clock position, and wherein the position of the leak is preferably determined based thereon.

In a further advantageous embodiment, the position of the leak, in particular in the circumferential direction of the tire, is determined in relation to the position of the sensor unit or of the tire pressure sensor.

In a further advantageous embodiment, the position of the leak is correlated to a tire-fixed, in particular one-dimensional, tire coordinate system, wherein the position of the sensor unit or of the tire pressure sensor forms the origin of the tire coordinate system.

In a further advantageous embodiment, the tire coordinate system is scaled by subdividing the tire in the circumferential direction into multiple, preferably 2 to 200, preferably precisely 12, sections of the same size, wherein the position of the leak is assigned to that section which corresponds to the determined position of the leak. The section which corresponds to the determined position of the leak is that section in which the leak occurs in the tire or in which the leak is located. The subdivision into multiple sections of the same size makes it possible to determine the position of the leakage point in a correspondingly reliable and precise manner depending on the specific variable or number of sections.

In a further advantageous embodiment, the determination of the position of the leak is only performed when a predetermined pressure drop of the tire pressure is established.

In a further advantageous embodiment, the pressure drop is ascertained by a comparison of a current tire pressure with a predetermined tire pressure threshold, wherein the pressure drop is preferably ascertained when the tire pressure is below the tire pressure threshold, and wherein the pressure drop is preferably ascertained when the tire pressure, after falling below the tire pressure threshold, drops further, in particular continually.

In a further advantageous embodiment, the sensor unit has a tire temperature sensor for capturing tire temperature data of the tire, wherein the tire temperature data are received by the processing device and temperature-normalized tire pressure data are established based on the tire temperature data and the tire pressure data, and wherein a time curve of the tire pressure of the tire is established with the aid of the temperature-normalized tire pressure data and the position of the leak is determined based on this curve.

In a further advantageous embodiment, following the determination of the position of the leak by the processing apparatus, a warning or indicating signal which indicates the determined position of the leak is output, in particular, to a driver of the vehicle and/or a vehicle-external server. In the case of an advantageous configuration, in which the position of the leak is determined in relation to the position of the sensor unit or of the tire pressure sensor, wherein the position of the leak is correlated to a tire-fixed, in particular one-dimensional, tire coordinate system, and wherein the position of the sensor unit or of the tire pressure sensor forms the origin of the tire coordinate system, the position of the leak is advantageously indicated by the, in particular graphical, warning or indicating signal in the tire coordinate system. In the case of an advantageous, further developing configuration, in which the tire coordinate system is scaled by subdividing the tire in the circumferential direction into multiple, preferably 2 to 200, preferably precisely 12, sections of the same size, wherein the position of the leak is assigned to that section which corresponds to the determined position of the leak, the section of the tire coordinate system to which the position of the leak was assigned is preferably indicated or highlighted by the, in particular, graphical, warning or indicating signal. The sensor unit and/or the tire pressure sensor is/are advantageously arranged in or on the valve of the tire. As a result, the position of the sensor unit and/or of the tire pressure sensor and, consequently, the origin of the tire coordinate system on the tire is, for example, known or simply visible to the driver and, thus, the position of the leak or the corresponding section in relation to the position of the sensor unit and/or of the tire pressure sensor or of the valve on the real tire can also be easily and quickly recognized or found.

Furthermore, an embodiment comprises a tire pressure monitoring system having a sensor unit comprising a tire pressure sensor for capturing tire pressure data of a tire of a vehicle and a processing device for evaluating the tire pressure data. The processing device is designed or adapted to perform the method according to the embodiment.

The described advantages and preferred embodiments for the method according to an embodiment also apply accordingly to the tire pressure monitoring system according to an embodiment.

### BRIEF DESCRIPTION OF THE DRAWINGS

Exemplary embodiments are explained in greater detail below with reference to the drawings, in which:

FIG. 1 is a schematic representation of a motor vehicle with a tire pressure monitoring system according to an embodiment;

FIG. 2 is a graph of a tire coordinate system of the tire pressure monitoring system from FIG. 1;

FIG. 3 is a diagram illustrating a curve of a tire pressure in the event of a leak as a function of the time;

FIG. 4 is a diagram illustrating a curve of a first derivative of the tire pressure from FIG. 3;

FIG. 5 is a diagram illustrating a curve of a second derivative of the tire pressure from FIG. 3; and

FIG. 6 is a flow chart of a method according to the embodiment of the tire monitoring system from FIG. 1 for determining the position of a leak.

### DETAILED DESCRIPTION

Parts corresponding to one another are constantly provided with the same reference numerals in all of the figures.

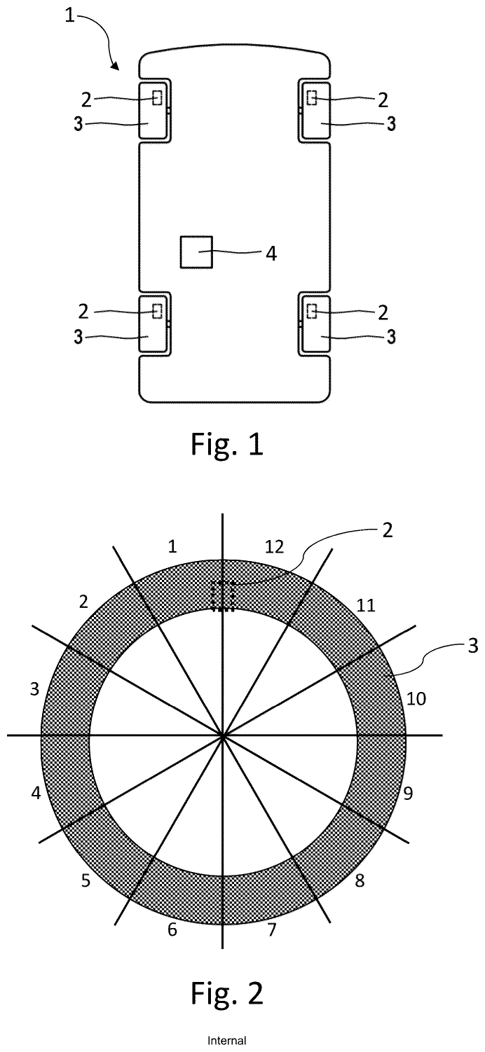

In FIG. 1, a vehicle with a tire pressure monitoring system 1 according to the embodiment is shown in a schematic representation. The tire pressure monitoring system 1 comprises multiple sensor units 2, wherein a sensor unit 2 is in each case arranged on a tire 3 of the vehicle, by way of example on a valve of a tire 3, as well as a central processing device 4 configured as a controller. Each sensor unit 2 has a fixed fastening position having fixed alignment with regard to the corresponding tire 3 and comprises a tire pressure sensor for capturing tire pressure data corresponding to a current internal air pressure of the tire, an acceleration sensor for capturing an acceleration relating to the tire and a tire temperature sensor for capturing tire temperature data of the tire. The data or information captured by the respective sensor units 2 are transmitted wirelessly to the processing device 4 and evaluated by the processing device 4.

The processing unit 4 is designed to determine temperature-normalized tire pressure data for each tire 3 based on the corresponding tire pressure data and tire temperature data, and to establish a time curve of the tire pressure 11 based on the temperature-normalized tire pressure data. Further, the processing device 4 is designed to perform the determination of the position of a leak in a tire 3 if, on the basis of the tire pressure data or the curve of the tire pressure 11, a predetermined pressure drop of the tire pressure 11 of the tire 3 indicating a leak is established, wherein this pressure drop is ascertained when the tire pressure 11 falls below a predetermined tire pressure threshold 12 and, after falling below the tire pressure threshold, drops further.

To this end, the processing device 4 is further designed, based on the established curve of the tire pressure 11 of the tire 3 and a rotation angle of the tire 3 established on the basis of the acceleration data of the acceleration sensor, to determine the position of the leak of the tire 3 in the circumferential direction in relation to the position of the sensor unit 2 or the tire pressure sensor. The position of the leak is correlated to a tire-fixed, one-dimensional tire coordinate system, wherein the position of the sensor unit 2 or of the tire pressure sensor forms the origin of the tire coordinate system, and wherein the tire coordinate system is scaled by subdividing the tire 3 in the circumferential direction into twelve sections of the same size (1 to 12). The position of the leak is assigned to that section of the twelve sections which corresponds to the determined position of the leak. Such a tire-fixed tire coordinate system is depicted in FIG. 2.

In order to determine the position of the leak, the processing device 4 is further designed to examine the curve of the tire pressure 11 after ascertaining the predetermined pressure drop for a tire pressure, and by way of example a suddenly occurring, consistent or substantially consistent tire pressure 11 for a predetermined period of time as a characteristic feature, and to determine the position of the leak with the aid of this characteristic feature or the occurrence of this characteristic feature. Consequently, after ascertaining the predetermined pressure drop, the (further) curve of the tire pressure 11 is subsequently examined to establish whether, by way of example, no change or no significant change in the tire pressure 11 is suddenly present for a predetermined period of time, that is to say, by way of example, whether no or only a very small (further) pressure drop of the tire pressure 11 is suddenly present in the time curve.

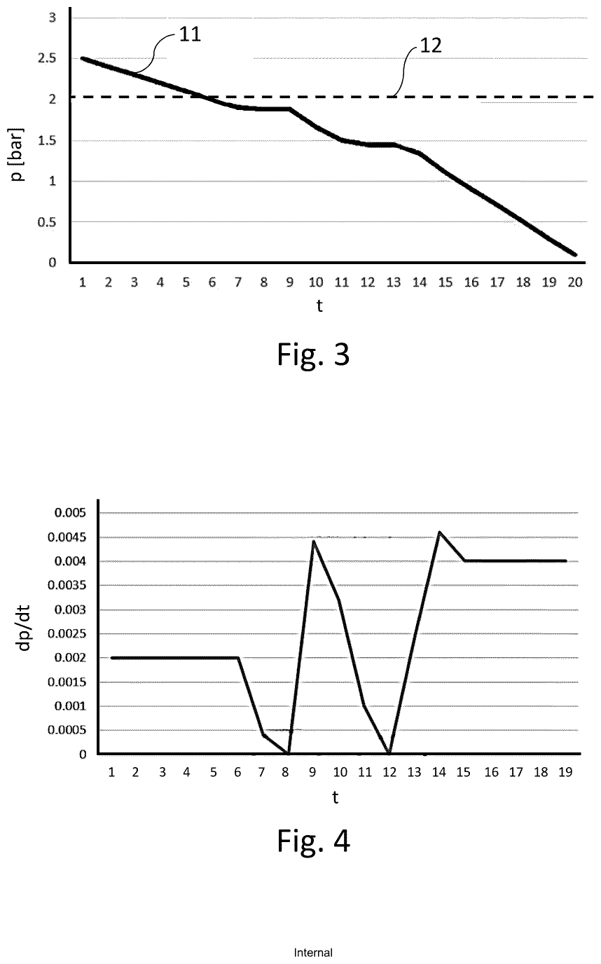

FIG. 3 shows a diagram which depicts a curve of a tire pressure in the event of a leak as a function of the time t. The curve of the tire pressure is provided with the reference numeral 11 and the tire pressure threshold is provided with the reference numeral 12. It is clear from this that the tire pressure 11 predominantly and continually drops overall due to the leak, wherein after falling below the tire pressure threshold 12 as a respective characteristic feature during two short time ranges or periods of time (during approximately t=7-9 and 11-13), a consistent or substantially consistent tire pressure 11 occurs, that is to say that no change or no pressure drop or no significant change or only a very small pressure drop of the tire pressure 11 is present here. Based on these characteristic features, the position of the leak can be determined.

The processing device 4 is, furthermore, designed to alternatively or additionally determine the position of the leak with the aid of a characteristic feature of a gradient of the curve of the tire pressure 11. That is to say that, in this case, the gradient of the curve of the tire pressure 11 is established and the position of the leak is determined based on the gradient of the curve.

To this end, a first derivative over time of the curve of the tire pressure 11 is established and the position of the leak is determined based on the first derivative over time. The first derivative over time of the curve of the tire pressure 11 or the curve of the first derivative over time is examined for a value equal to or virtually zero as a characteristic feature, wherein the position of the leak is determined with the aid of this characteristic feature or the occurrence of this characteristic feature. Alternatively or additionally, a second derivative over time of the curve of the tire pressure 11 is established and the position of the leak is determined based on the second derivative over time. The second derivative over time of the curve of the tire pressure 11 or the curve of the second derivative over time is examined for a global or local minimum value as a (further) characteristic feature, wherein the position of the leak is alternatively or additionally determined with the aid of this (further) characteristic feature or the occurrence of this (further) characteristic feature.

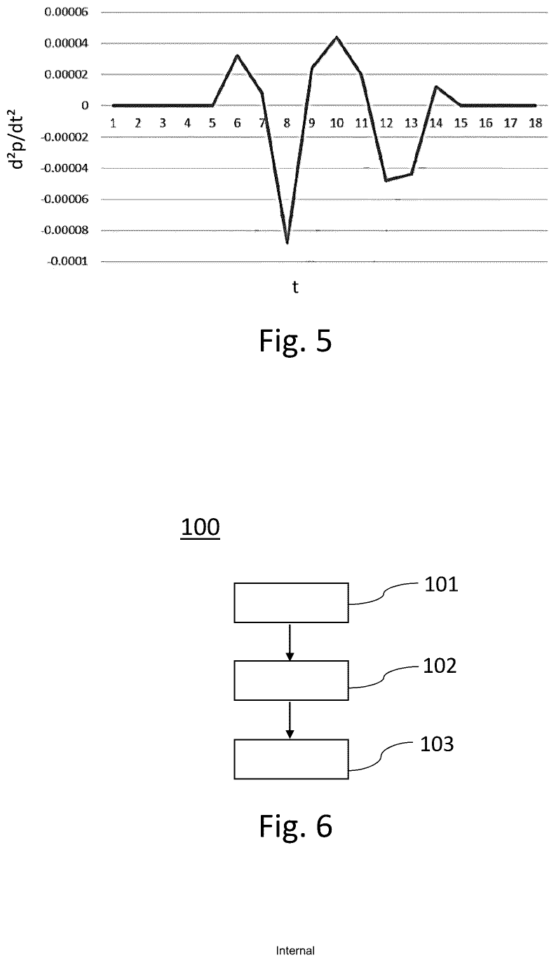

In FIGS. 4 and 5, two diagrams are shown, which each show a curve of a derivative over time of the tire pressure 11 from FIG. 3. FIG. 4 shows the curve of the first derivative of the curve of the tire pressure 11 and FIG. 5 shows the curve of the second derivative of the curve of the tire pressure 11. As can be seen from FIG. 4, the curve of the first derivative of the tire pressure 11 has, as a respective characteristic feature, approximately at t=8 and at t=12, a value of zero. That is to say that, here, there is in each case a consistent tire pressure 11 and, consequently, there is no pressure drop in each case. It can be seen from FIG. 5 that the curve of the second derivative of the tire pressure 11 has, as respective characteristic features, approximately at t=8 and at t=12, a global or local minimum value. Based on these characteristic features, the position of the leak can be determined.

The processing device 4 is further designed, at a determined position of the leak, to activate the output of a warning or indicating signal which indicates the determined position of the leak to a driver of the vehicle and/or a vehicle-external server, for example a vehicle or tire repair shop, or a fleet operator of the vehicle. The warning or indicating signal comprises a graphical representation which displays the position of the leak in the tire coordinate system, wherein that section of the tire coordinate system to which the position of the leak is assigned is highlighted. The graphical representation can correspond to the representation shown in FIG. 2 or can be based on this, wherein the section assigned to the position of the leak is then particularly highlighted here. As a result, in particular, the origin of the tire coordinate system and, consequently, the position of the sensor unit 2 fastened to the tire valve and also the position of the leak or the corresponding section in relation to the position of the sensor unit 2 or the tire valve is displayed, for example, to the driver or an employee of a vehicle or tire repair shop, as a result of which the leak in the real tire 3 can then be found quickly and easily.

FIG. 6 shows a flow chart of a method 100 of the tire monitoring system 1 from FIG. 1 for determining the position of a leak.

In a step 110, it is initially checked, on the basis of the tire pressure data or the curve of the tire pressure 11, whether a predetermined pressure drop of the tire pressure of the tire 3 indicating a leak is present, wherein this pressure drop is ascertained when the tire pressure 11 falls below a predetermined tire pressure threshold 12 and, after falling below the tire pressure threshold 12, drops further.

If such a pressure drop is established, the position of the leak of the tire 3 is determined in a next step 120. To this end, the first derivative over time of the curve of the tire pressure 11 or the curve of the first derivative over time is examined for a value equal to or virtually zero as a characteristic feature. As soon as such a characteristic feature is recognized, the position of the leak in the circumferential direction of the tire in relation to the position of the sensor unit 2 or of the tire pressure sensor is determined with the aid of this characteristic feature and a rotation angle of the tire 3 is established on the basis of the acceleration data of the acceleration sensor. The position of the leak is correlated to a tire-fixed, one-dimensional tire coordinate system, wherein the position of the sensor unit 2 or of the tire pressure sensor forms the origin of the tire coordinate system, and wherein the tire coordinate system is scaled by subdividing the tire in the circumferential direction into twelve sections of the same size. The position of the leak is assigned to that section of the twelve sections which corresponds to the determined position of the leak.

In a next step 130, the output of a warning or indicating signal, which indicates the determined position of the leak, to a driver of the vehicle and/or a vehicle-external server is activated. The warning or indicating signal comprises a graphical representation which displays the position of the leak in the tire coordinate system, wherein that section of the tire coordinate system to which the position of the leak is assigned is highlighted.

Such a method or such a configuration of the tire pressure monitoring system 1 makes it possible to determine the position of a leak in a tire 3 fitted to a vehicle in a simple and reliable manner. In addition, the determination and corresponding notification of the position of the leak, for example, to the driver and/or a vehicle- or tire repair shop means that a decision regarding the possibility of repairing the tire can be made simply and quickly and/or the tire can be quickly repaired.

1. A method of determining a position of a leak in a tire fitted to a vehicle, which has a sensor unit having a tire pressure sensor for capturing tire pressure data of the tire, the method comprising:
receiving the tire pressure data by a processing device of the vehicle;
determining a time curve of the tire pressure of the tire based on the tire pressure data; and
determining the position of the leak based on the time curve of the tire pressure.

2. The method according to claim 1, wherein determining the position of the leak comprises determining the position of the leak based on a suddenly occurring, consistent or substantially consistent tire pressure, for a predetermined period of time.

3. The method according to claim 1, wherein determining the position of the leak comprises determining the position of the leak based on a gradient of the time curve of the tire pressure.

4. The method according to claim 3, further comprising determining a first derivative over time and/or a second derivative over time of the time curve of the tire pressure,
wherein determining the position of the leak comprises determining the position of the leak based on a curve of the first derivative over time and/or a curve of the second derivative over time.

5. The method according to claim 4, wherein the first derivative over time of the time curve of the tire pressure is equal to or virtually zero.

6. The method according to claim 5, wherein a characteristic feature is a global or local minimum value of the second derivative over time of the time curve of the tire pressure, and wherein the position of the leak is determined based on the global or local minimum value of the second derivative over time of the time curve of the tire pressure.

7. The method according to claim 1, further comprising:
receiving acceleration data captured by an acceleration sensor; and
determining a rotation angle of the tire based on the acceleration data,
wherein determining the position of the leak comprises determining the position of the leak based on the rotation angle.

8. The method according to claim 1, wherein determining the position of the leak comprises determining the position of the leak in relation to a position of the sensor unit or the tire pressure sensor.

9. The method according to claim 8, wherein the position of the leak is correlated to a tire-fixed, one-dimensional, tire coordinate system, and
wherein the position of the sensor unit or of the tire pressure sensor forms the origin of the tire coordinate system.

10. The method according to claim 9, wherein the tire coordinate system is scaled by subdividing the tire in the circumferential direction into multiple sections of a same size, and
wherein the position of the leak is assigned to a section which corresponds to the position of the leak.

11. The method according to claim 1, further comprising determining a predetermined pressure drop of the tire pressure,
wherein determining the position of the leak comprises determining the position of the leak in response to determining the predetermined pressure drop of the tire pressure.

12. The method according to claim 11, wherein determining the pressure drop comprises a comparison of a current tire pressure with a predetermined tire pressure threshold.

13. The method according to claim 1, further comprising receiving tire temperature data from a tire temperature sensor of the tire; and
determining temperature-normalized tire pressure data based on the tire temperature data and the tire pressure data,
wherein determining the time curve comprises determining the time curve of the tire pressure of the tire based on the temperature-normalized tire pressure data.

14. The method according to claim 1, further comprising outputting a warning or indicating signal which indicates the determined position of the leak.

15. A tire pressure monitoring system comprising:
a sensor unit comprising a tire pressure sensor for capturing tire pressure data of a tire of a vehicle; and
a processing device configured to receive the tire pressure data, determine a time curve of the tire pressure of the tire based on the tire pressure data, and determine the position of the leak based on the time curve of the tire pressure.
